(19) United States
(12) Patent Application Publication
(10) Pub. No.: US 2026/0285632 A1
(43) Pub. Date: Sep. 24, 2026

(54) GLASS ROLL

(71) Applicant: CORNING INCORPORATED, CORNING, NY (US)

(72) Inventor: Goo Soo Lee, Seoul (KR)

(21) Appl. No.: 19/489,333

(22) PCT Filed: Jun. 3, 2024
(86) PCT No.: PCT/US2024/032195

§ 371 Date: Dec. 2, 2025

(30) Foreign Application Priority Data
Jun. 7, 2023 (KR) 10-2023-073083

(51) Int. Cl. B65H 18/28; C03B 35/14

(52) U.S. Cl. CPC B65H 18/28; B65H 2301/414324; B65H 2701/1842; B65H 2701/515; C03B 35/14

(57) ABSTRACT

Provided is a glass roll. The glass roll includes a winding core having a central axis, a carrier film wound on the winding core about the central axis, and a glass ribbon wound on the carrier film about the central axis and attached onto the carrier film, wherein the carrier film includes an adhesive face in contact with the glass ribbon and a non-adhesive face opposite the adhesive face, and wherein the carrier film includes a peel adhesion of less than or equal to 2.9 gf/in².

### BACKGROUND

### 1. Cross-Reference to Related Applications

This application claims the benefit of priority under 35 U.S.C. § 119 of Korean Patent Application Serial No. 10-2023-073083 filed on Jun. 7, 2023, the content of which is relied upon and incorporated herein by reference in its entirety.

### 2. Field

The disclosure relates to a glass roll. More particularly, the disclosure relates to a glass roll including a glass ribbon wound on a winding core and a carrier film.

### 3. Description of the Related Art

Glass may be processed to a thin thickness and suitable for a roll-to-roll process. Glass that is suitable for a roll-to-roll process may have appropriate optical sharpness, surface quality, bendability, flexibility, and excellent thermodynamic stability. Glass with such flexibility may be employed in various applications, such as photovoltaic cells, flexible displays, and wearable electronic devices. In particular, various attempts have been proposed to integrate components of electronic devices on a glass surface using the roll-to-roll process of glass. As the roll-to-roll process is integrated into thin film coating processes, such as a coating process, a print process, and a deposition process of a metal layer, a semiconductor layer, a transparent electrode layer, an inorganic material layer, an organic material layer, or the like, manufacturing yield may be improved. On the other hand, the coating process of a metal layer, a semiconductor layer, a transparent electrode layer, an inorganic material layer, or an organic material layer for some applications is performed under vacuum at a relatively high temperature, and thus, it is necessary to develop a carrier film that has excellent compatibility with this process and can prevent damage to the glass during the roll-to-roll process.

### SUMMARY

Provided is a glass roll that may prevent damage to glass and facilitates transportation of glass in a high temperature process and a roll-to-roll process.

According to an aspect of the disclosure, a glass roll includes a winding core having a central axis, a carrier film wound on the winding core about the central axis, and a glass ribbon wound on the carrier film about the central axis and attached onto the carrier film, wherein the carrier film may include an adhesive face in contact with the glass ribbon and a non-adhesive face opposite the adhesive face, and wherein the carrier film may include a peel adhesion of less than or equal to 2.9 gf/in².

In some embodiments, the carrier film may have a modulus of 250 MPa to 15 GPa.

In some embodiments, the glass ribbon may have a thickness of 10 micrometers to 100 micrometers, and the carrier film may have a thickness of 10 micrometers to 200 micrometers.

In some embodiments, the carrier film may have a roughness of less than or equal to about 30 nm.

In some embodiments, the carrier film may have a peel adhesion of less than or equal to 1.1 gf/in².

In some embodiments, the carrier film may include a base film including a first surface and a second surface, and an adhesive layer attached onto the first surface of the base film, and wherein a face of the adhesive layer defines the adhesive face of the carrier film.

In some embodiments, the carrier film may further include a non-adhesive layer attached on the second surface of the base film, and the surface of the non-adhesive layer may define the non-adhesive face of the carrier film.

In some embodiments, the second surface of the base film defines the non-adhesive face of the carrier film.

In some embodiments, the base film may include at least one of polypropylene and polyethylene, and the adhesive layer may include at least one of polyolefin plastomers, alpha olefin copolymers, silicone resins, and photoreactive adhesive materials.

In some embodiments, the non-adhesive face of the carrier film may have no adhesion to a portion of the glass ribbon that is arranged adjacent to the non-adhesive face to be in contact with the non-adhesive face, and when stored for more than 5 days at a temperature of 20° C. under a load of 1.97 gf/mm² in a state of the non-adhesive face of the carrier film contacting the portion of the glass ribbon, any component of the carrier film may not be transferred onto a surface of the glass ribbon.

In some embodiments, the adhesive face of the carrier film may have a peel adhesion of less than or equal to 2.9 gf/in² at a temperature of 20° C. to 170° C.

According to another aspect of the disclosure, a glass roll including a winding core having a central axis, a carrier film wound on the winding core about the central axis, and a glass ribbon wound on the carrier film about the central axis and attached onto the carrier film, wherein the carrier film may include a base film including a first surface and a second surface opposite the first surface, an adhesive layer attached on the first surface of the base film, wherein the carrier film may include an adhesive face and a non-adhesive face opposite the adhesive face, the second surface of the base film forms the non-adhesive face, and the carrier film is attached to the glass ribbon such that the adhesive layer is in contact with the glass ribbon, and wherein the carrier film may include a peel adhesion of less than or equal to 2.9 gf/in².

In some embodiments, the carrier film may have a modulus of 250 MPa to 15 GPa, and the glass ribbon may have the thickness of 10 micrometers to 100 micrometers.

In some embodiments, the carrier film may have a roughness of less than or equal to 30 nm.

In some embodiments, the carrier film may have a peel adhesion of less than or equal to 1.1 gf/in².

According to another aspect of the disclosure, a glass roll including a winding core having a central axis, a carrier film wound on the winding core about the central axis, and a glass ribbon wound on the carrier film about the central axis and attached onto the carrier film, wherein the carrier film may include an adhesive face and a non-adhesive face opposite the adhesive face, and wherein the carrier film may include a peel adhesion of less than or equal to 2.9 gf/in² and a modulus ranging from 250 MPa to 15 GPa.

In some embodiments, the base film may include at least one of polypropylene and polyethylene, and the adhesive layer may include at least one of polyolefin plastomers, alpha olefin copolymers, silicone resins, and photoreactive adhesive materials.

In some embodiments, the non-adhesive face of the carrier film may have no adhesion to a portion of the glass ribbon that is arranged adjacent to the non-adhesive face to be in contact with the non-adhesive face, and when stored for more than 5 days at a temperature of 20° C. under a load of 1.97 gf/mm² in a state of the non-adhesive face of the carrier film contacting the portion of the glass ribbon, any component of the carrier film may not be transferred onto a surface of the glass ribbon.

In some embodiments, the adhesive face of the carrier film may have a peel adhesion of less than or equal to 2.9 gf/in² at a temperature of 20° C. to 170° C.

In some embodiments, the glass roll may further include a leader film arranged at a front side of the glass ribbon and attached on the adhesive face of the carrier film, one end of the leader film being attached on the winding core and overlapping a portion of the carrier film in a state to be unwound in a planar shape, and a trailer film arranged at a rear side of the glass ribbon, and attached on the adhesive face of the carrier film.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a glass roll according to some embodiments;

FIG. 2 is a cross-sectional view of the glass roll of FIG. 1 in an unwound state;

FIG. 3 is an enlarged view of a region A of FIG. 1 showing a glass roll in a winding state;

FIG. 4 is an enlarged view of a region B of FIG. 2;

FIG. 5 is a cross-sectional view of a portion of a glass roll according to some embodiments;

FIG. 6 is a schematic view of a roll-to-roll manufacturing apparatus by using the glass roll according to some embodiments; and

FIG. 7 is a schematic view of an aging test method by using the glass roll according to some embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the disclosure will be described below in detail with reference to the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Throughout the drawings, like reference numerals denote like elements. Furthermore, various components and regions in the drawings are schematically illustrated. Accordingly, the present invention is not limited by the relative size or distance drawn in the accompanying drawings.

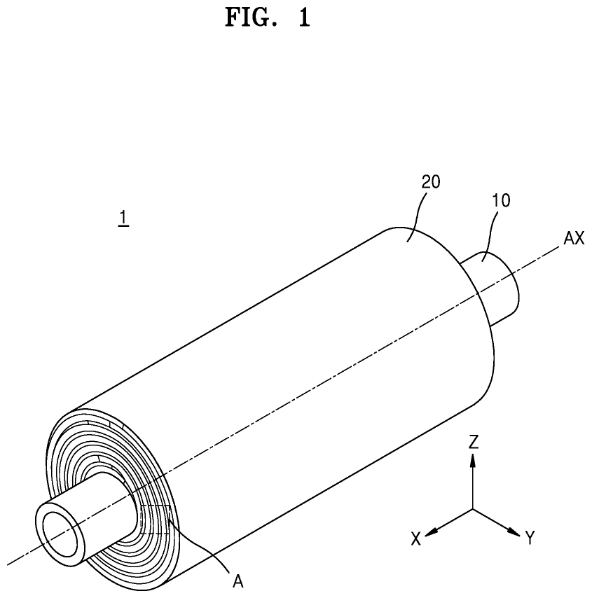

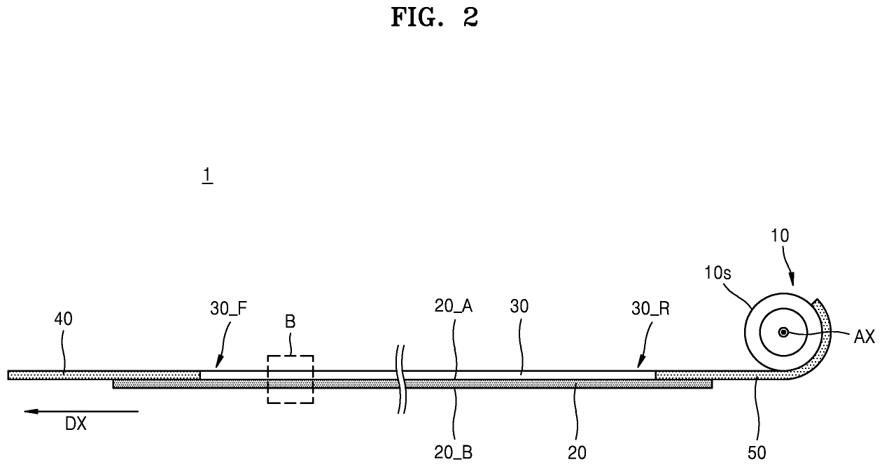

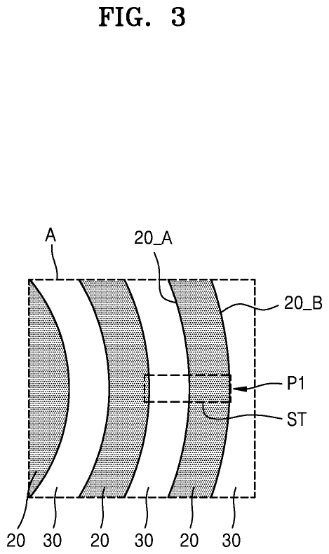

FIG. 1 is a schematic view of a glass roll 1 according to some embodiments. FIG. 2 is a cross-sectional view of the glass roll 1 of FIG. 1 in an unwound state. FIG. 3 is an enlarged view of a region A of FIG. 1 showing the glass roll 1 in a winding state.

Referring to FIGS. 1 to 3, the glass roll 1 may include a winding core 10 and a stack body of a carrier film 20 and a glass ribbon 30 wound on the winding core 10.

The winding core 10 may have an outer surface 10s having a cylinder shape, and the stack body of the carrier film 20 and the glass ribbon 30 may be wound on the outer surface 10s of the winding core 10. The stack body of the carrier film 20 and the glass ribbon 30, which is wound around the winding core 10, may be configured to be continuously unwound from the winding core 10 through a roll-to-roll process, for example, in a release direction DX. The winding core 10 may have an empty or a hollow cylindrical shape, or in other embodiments, the winding core 10 may be a filled or a solid cylindrical shape. In some embodiments, the diameter of the winding core 10 may be about 6 inches or more, but the disclosure is not limited thereto.

The carrier film 20 may include an adhesive face 20_A and a non-adhesive face 20_B, and the glass ribbon 30 may be attached on the adhesive face 20_A of the carrier film 20. The carrier film 20 may be attached on the glass ribbon 30 over the entire area of the glass ribbon 30.

When the glass ribbon 30 is unwound from the winding core 10 in a roll-to-roll process and a device manufacturing process such as a deposition process, a coating process, a cleaning process, and the like, is applied to a surface of the glass ribbon 30, the carrier film 20 may be used as a carrier for supporting the glass ribbon 30. Furthermore, when the glass ribbon 30 is transferred or transported by being wound in the form of a glass roll, the carrier film 20 may function as a buffer material for preventing the telescoping phenomenon of the glass ribbon 30. The telescoping phenomenon refers to that a portion of a glass roll (for example, the winding core 10 and an inner portion of the glass roll 1 wound close to the winding core 10) slides in a lateral direction along a central axis AX so that the winding core 10 and a portion of the glass ribbon 30 expand from the glass roll 1 in the lateral direction.

In some embodiments, the carrier film 20 may have a peel adhesion of less than or equal to 2.9 gf/in² or less. For example, the carrier film 20 may have a peel adhesion of less than or equal to 2.9 gf/in² or less, a peel adhesion of less than or equal to 2.7 gf/in², a peel adhesion of less than or equal to 2.5 gf/in², a peel adhesion of less than or equal to 2.3 gf/in², a peel adhesion of less than or equal to 2.1 gf/in², a peel adhesion of less than or equal to 1.9 gf/in², a peel adhesion of less than or equal to 1.7 gf/in², a peel adhesion of less than or equal to 1.5 gf/in², a peel adhesion of less than or equal to 1.3 gf/in², a peel adhesion of less than or equal to 1.1 gf/in², or a peel adhesion of less than or equal to 1.0 gf/in². In some specific embodiments, the carrier film 20 may have a peel adhesion of less than or equal to 1.1 gf/in².

In some embodiments, the carrier film 20 may have a peel adhesion of less than or equal to 2.9 gf/in² or less at a temperature of 20° C. to 170° C. For example, the carrier film 20 may include a material having excellent thermal stability, and have, for example, a peel adhesion of less than or equal to 2.9 gf/in² or less under a temperature range of 20° C. to 170° C. Accordingly, even when a device manufacturing process performed at a relatively high temperature is applied to the stack body of the carrier film 20 and the glass ribbon 30, for example, the carrier film 20 is exposed to a high temperature for several minutes to several days, the carrier film 20 may have a stable peel adhesion characteristic.

When the carrier film 20 has a peel adhesion of greater than 2.9 gf/in² after exposed to a high temperature, for example, after a device manufacturing process, such as a vacuum-based deposition or coating process and a cleaning process, is applied to the glass ribbon 30, in a process of removing the carrier film 20 from the glass ribbon 30, the carrier film 20 may not be easily separated or removed from the glass ribbon 30. In this case, there may be an adverse effect on the electrical or optical performance of devices manufactured on the glass ribbon 30.

In some embodiments, the carrier film 20 may have a peel adhesion of greater than 0.0 gf/in², for example, a peel adhesion of greater than 0.1 gf/in², a peel adhesion of greater than 0.3 gf/in², a peel adhesion of greater than 0.5 gf/in², or a peel adhesion of greater than 0.7 gf/in². For example, when the carrier film 20 has no peel adhesion, and a device manufacturing process, such as a vacuum-based deposition or coating process and a cleaning process is applied to the glass ribbon 30, it may be difficult to stably support the glass ribbon 30 on the carrier film 20.

In some embodiments, the carrier film 20 may have a modulus of 250 MPa to 15 GPa. In some embodiments, the carrier film 20 may have a modulus of 250 MPa to 1 GPa. In some embodiments, the carrier film 20 may have a modulus of 1 GPa to 15 GPa. In some embodiments, the carrier film 20 may have a modulus in any one range of 250 MPa to 2 GPa, 250 MPa to 5 GPa, 250 MPa to 10 GPa, 350 MPa to 1 GPa, 350 MPa to 2 GPa, 350 MPa to 5 GPa, 350 MPa to 10 GPa, 350 MPa to 15 GPa, 500 MPa to 1 GPa, 500 MPa to 2 GPa, 500 MPa to 5 GPa, 500 MPa to 10 GPa, 500 MPa to 15 GPa, 1 GPa to 2 GPa, 1 GPa to 3 GPa, 1 GPa to 5 GPa, 1 GPa to 10 GPa, 2 GPa to 5 GPa, 2 GPa to 10 GPa, 2 GPa to 15 GPa, 3 GPa to 5 GPa, 3 GPa to 10 GPa, and 3 GPa to 15 GPa.

In some embodiments, as the carrier film 20 has a modulus of 250 MPa to 15 GPa, when a mechanical shock or vacuum is applied to the stack body of the carrier film 20 and the glass ribbon 30 that is being transferred or transported by being wound on the winding core 10, the carrier film 20 provides a buffering force to the glass ribbon 30 so that the telescoping phenomenon may be prevented or reduced.

In some embodiments, the carrier film 20 may have a roughness of less than or equal to 30 nm. For example, the carrier film 20 may have a roughness of less than or equal to 30 nm, less than or equal to 25 nm, less than or equal to 20 nm, less than or equal to 15 nm, less than or equal to 10 nm, less than or equal to 5 nm, or less than or equal to 3 nm. As the carrier film 20 has a roughness of less than or equal to 30 nm, the glass ribbon 30 may be attached on the carrier film 20 forming a stable interface, and the surface morphology of the carrier film 20 may prevent local stress from being applied to the glass ribbon 30.

In some embodiments, the carrier film 20 may have a thickness of 10 to 200 micrometers. When the thickness of the carrier film 20 is less than 10 micrometers, it may be difficult to provide sufficient stiffness to support the glass ribbon 30 in the roll-to-roll process and/or in a device manufacturing process performed at a relatively high temperature. When the thickness of the carrier film 20 is greater than 200 micrometers, the volume occupied by the carrier film 20 in the glass roll 1 increases so that the length of the glass ribbon 30 may be reduced. Accordingly, when the thickness of the carrier film 20 is in a range of 10 to 200 micrometers, sufficient stiffness to support the glass ribbon 30 may be provided, and simultaneously, the glass ribbon 30 having a relatively long length may be accommodated in the glass roll 1.

The glass ribbon 30 may be attached on the adhesive face 20_A of the carrier film 20. The glass ribbon 30 may include, for example, silicate glass, borosilicate glass, aluminosilicate glass, boroaluminosilicate glass, or a combination thereof, each of which may or may not include an alkali element(s). The glass ribbon 30 may be, for example, Willow® glass, which is obtainable from Corning Incorporated.

In some embodiments, the thickness of the glass ribbon 30 may be a range of about 10 to 100 micrometers. In some embodiments, the thickness of the glass ribbon 30 may have a range of about 10 to 40 micrometers, about 10 to 50 micrometers, about 10 to 60 micrometers, about 10 to 80 micrometers, about 20 to 40 micrometers, about 20 to 50 micrometers, about 20 to 60 micrometers, about 30 to 50 micrometers, about 30 to 60 micrometers, about 30 to 80 micrometers, about 40 to 60 micrometers, about 40 to 80 micrometers, about 50 to 80 micrometers, about 50 to 100 micrometers, about 60 to 80 micrometers, or about 60 to 100 micrometers.

In some embodiments, when the thickness of the glass ribbon 30 is less than 10 micrometers, handling the glass ribbon 30 may be difficult in the roll-to-roll process and/or the device manufacturing process performed at a relatively high temperature the glass ribbon 30, and when the thickness of the glass ribbon 30 is greater than 100 micrometers, it may be difficult to wind the glass ribbon 30 on the winding core 10.

In some embodiments, the glass ribbon 30, when unwound in the release direction DX, may have a length of 10 to 200 meters. An appropriate value may be selected as the length of the glass ribbon 30 by reflecting the manufacturing process applied to the glass ribbon 30. In some embodiments, the thickness of the glass ribbon 30 may be greater than the thickness of the carrier film 20, and the stack body of the carrier film 20 and the glass ribbon 30 may be wound on the winding core 10 by a relatively large length.

The stack body of the carrier film 20 and the glass ribbon 30 may be stored or transferred by being wound on the outer surface 10s of the winding core 10, that is, in the form of the glass roll 1. As illustrated in FIG. 3, while the glass roll 1 is in a winding state, a portion of the glass ribbon 30 is attached on the adhesive face 20_A of the carrier film 20 forming a stack ST of the carrier film 20 and the glass ribbon 30, and the non-adhesive face 20_B of the carrier film 20 may be arranged in contact with a portion P1 of the glass ribbon 30 adjacent thereto. Even when the non-adhesive face 20_B of the carrier film 20 contacts the portion P1 of the glass ribbon 30 adjacent thereto, the non-adhesive face 20_B of the carrier film 20 may not adhere to the portion P1 of the glass ribbon 30.

For example, when the non-adhesive face 20_B of the carrier film 20 and the portion P1 of the glass ribbon 30 are brought in contact with each other and stored under a load of 1.97 gf/mm² at a temperature of 20° C. for more than 5 days, the non-adhesive face 20_B of the carrier film 20 may not be attached on the portion P1 of the glass ribbon 30. When the glass roll 1 is in a winding state or when the non-adhesive face 20_B of the carrier film 20 and the portion P1 of the glass ribbon 30 are brought in contact with each other and stored under a load of 1.97 gf/mm² at a temperature of 20° C. for more than 5 days, by separating the non-adhesive face 20_B of the carrier film 20 from the portion P1 of the glass ribbon 30, and observing a surface of the portion P1 of the glass ribbon 30 with the naked eye or analyzing the composition of an organic material, it may be confirmed that a portion of the carrier film 20 is not left.

A leader film 40 may be attached to a first end of the stack body of the carrier film 20 and the glass ribbon 30, and a trailer film 50 may be attached to a second end of the stack body of the carrier film 20 and the glass ribbon 30. The leader film 40 and the trailer film 50 may be attached on the adhesive face 20_A of the carrier film 20. For example, the leader film 40 may be closely attached to a front end 30_F of the glass ribbon 30, and the trailer film 50 may be closely attached to a rear end 30_R of the glass ribbon 30. The stack body of the carrier film 20 and the glass ribbon 30 may be connected to the winding core 10 through the trailer film 50, and arranged to be wound on the outer surface 10s of the winding core 10.

The rear end 30_R of the glass ribbon 30 may refer to an end of the glass ribbon 30 disposed adjacent to the winding core 10, and the front end 30_F of the glass ribbon 30 may refer to an end of the glass ribbon 30 disposed far from the winding core 10. For example, when the stack body of the carrier film 20 and the glass ribbon 30 is unwound from the glass roll 1, the front end 30_F of the glass ribbon 30 may be first unwound in a planar shape and then the rear end 30_R of the glass ribbon 30 may be finally unwound in a planar shape. The trailer film 50 may prevent the glass ribbon 30 from being damage in a process in which the stack body of the carrier film 20 and the glass ribbon 30 is wound on the winding core 10, and the leader film 40 may prevent the glass ribbon 30 from being damaged in a process in which the stack body of the carrier film 20 and the glass ribbon 30 is unwound from a state of the glass roll 1.

In some embodiments, the leader film 40 and the trailer film 50 may include polyethylene (PE), polypropylene (PP), polyethylene terephthalate (PET), or a combination thereof.

In some embodiments, the leader film 40 may be omitted, and an end of the carrier film 20 (for example, an end of the adhesive face 20_A of the carrier film 20) may be attached directly on the outer surface 10s of the winding core 10. In this case, as the front end 30_F of the glass ribbon 30 and the end of the carrier film 20 are arranged apart from each other by a relatively large distance, the glass ribbon 30 may not be in direct contact with the outer surface 10s of the winding core 10.

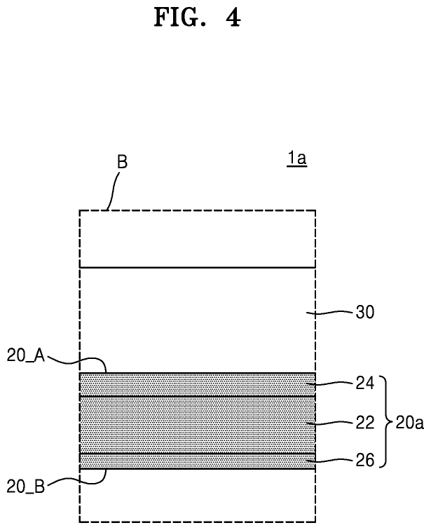

FIG. 4 is an enlarged view of a region B of FIG. 2.

Referring to FIG. 4, the carrier film 20 may have a double layer structure. In some embodiments, the carrier film 20 may include a base film 22 and an adhesive layer 24 attached on a first surface of the base film 22. A surface of the adhesive layer 24, for example, a surface opposite to the surface of the adhesive layer 24 contacting the first surface of the base film 22 may form the adhesive face 20_A of the carrier film 20.

In some embodiments, the base film 22 may include at least one of polypropylene and polyethylene. In some embodiments, the base film 22 may include atactic polypropylene. The first surface and the second surface of the base film 22 may be non-adhesive, and the second surface of the base film 22 may form the non-adhesive face 20_B of the carrier film 20.

In some embodiments, the adhesive layer 24 may include at least one of polyolefin plastomers, alpha olefin copolymers, silicone resins, and photoreactive adhesive materials. In some embodiments, the adhesive layer 24 may be formed on the first surface of the base film 22 uniformly and to a relatively thin thickness. For example, the thickness of the adhesive layer 24 may correspond to 10% to 50% of the thickness of the carrier film 20.

The adhesive layer 24 may form a stable interface over the entire area of the base film 22, and cover the first surface of the base film 22. Accordingly, appearance defects, such as air bubbles, bubbles, wrinkles, or bumps, may not be provided between the adhesive layer 24 and the first surface of the base film 22.

In some embodiments, the base film 22, with the adhesive layer 24, may provide a modulus or roughness required for the carrier film 20, and the adhesive layer 24 is attached on the base film 22 to exert a stable peel adhesion with respect to the glass ribbon 30. For example, the adhesive layer 24 may have a peel adhesion of less than or equal to 2.9 gf/in² or less, even at a relatively high temperature.

In some embodiments, the carrier film 20 may be provided in a state in which a liner (not shown) is further attached on the adhesive layer 24, and in a process in which the glass ribbon 30 is attached on the carrier film 20, the liner may be removed and the glass ribbon 30 may be attached on the adhesive face 20_A of the carrier film 20 (for example, the surface of the adhesive layer 24 exposed after the liner is removed).

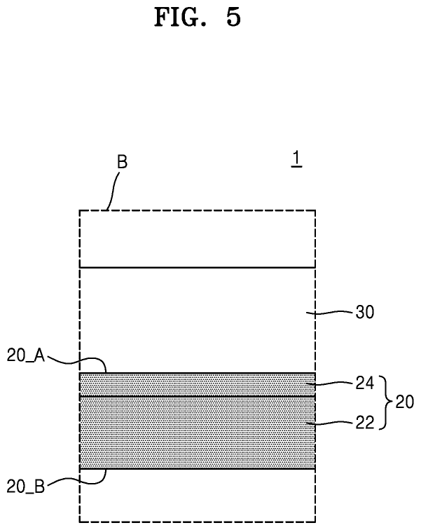

FIG. 5 is a cross-sectional view of a portion of a glass roll 1a according to some embodiments.

Referring to FIG. 5, a carrier film 20a may have a triple layer structure. In some embodiments, the carrier film 20a may include the base film 22, the adhesive layer 24 attached on the first surface of the base film 22, and a non-adhesive layer 26 attached on the second surface of the base film 22. The surface of the adhesive layer 24, for example, a surface opposite to the surface of the adhesive layer 24 in contact with the first surface of the base film 22, may form the adhesive face 20_A of the carrier film 20, and a surface of the non-adhesive layer 26, for example, a surface opposite to the surface of the non-adhesive layer 26 in contact with the second surface of the base film 22, may form the non-adhesive face 20_B of the carrier film 20.

In some embodiments, the base film 22 may include at least one of polypropylene and polyethylene. In some embodiments, the base film 22 may include atactic polypropylene. The first surface and the second surface of the base film 22 may be non-adhesive, and the second surface of the base film 22 may form the non-adhesive face 20_B of the carrier film 20.

In some embodiments, the adhesive layer 24 may include at least one of polyolefin plastomers, alpha olefin copolymers, silicone resins, and photoreactive adhesive materials. In some embodiments, the adhesive layer 24 may be formed on the first surface of the base film 22 uniformly and to a relatively thin thickness. For example, the thickness of the adhesive layer 24 may correspond to 10% to 50% of the thickness of the carrier film 20.

In some embodiments, the non-adhesive layer 26 may include at least one of atactic polypropylene and polyethylene.

The adhesive layer 24 may form a stable interface over the entire area of the base film 22, and cover the first surface of the base film 22. Accordingly, appearance defects, such as air bubbles, bubbles, wrinkles, or bumps, may not be provided between the adhesive layer 24 and the first surface of the base film 22. Furthermore, the non-adhesive layer 26 may form a stable interface over the entire area of the base film 22, and cover the second surface of the base film 22. Accordingly, appearance defects such as air bubbles, bubbles, wrinkles, or bumps may not be provided between the non-adhesive layer 26 and the second surface of the base film 22.

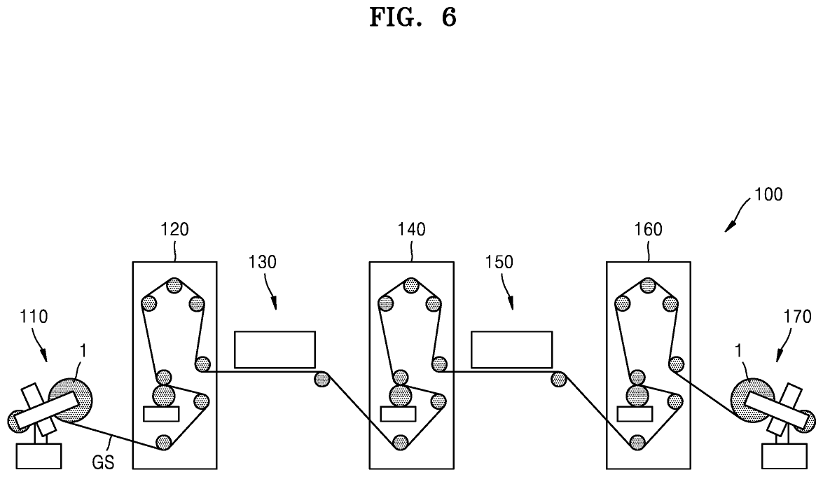

FIG. 6 is a schematic view of a roll-to-roll manufacturing apparatus 100 by using the glass roll according to some embodiments.

Referring to FIG. 6, the roll-to-roll manufacturing apparatus 100 may be an apparatus for performing a roll-to-roll manufacturing method by using the glass roll 1 according to some embodiments described with reference to FIGS. 1 to 5, for example, an apparatus for forming electronic devices on the glass ribbon 30 wound around the glass roll 1. In some embodiments, the roll-to-roll manufacturing apparatus 100 may be integrated into an apparatus for manufacturing a device, such as a solar cell, smart glass, or a display device.

The roll-to-roll manufacturing method using the roll-to-roll manufacturing apparatus 100 may include a plurality of material layer forming units 120 to 160 for coating, depositing, or printing a metal layer, a semiconductor layer, a transparent electrode layer, an inorganic material layer, an organic material layer, or the like, on the glass ribbon 30 to form constituent elements of a device, such as a solar cell, smart glass, or a display device. In some embodiments, at least one of the material layer forming units 120 to 160 for coating, deposition, or printing a metal layer, a semiconductor layer, a transparent electrode layer, an inorganic material layer, an organic material layer, or the like may be performed at a relatively high temperature, for example, at a temperature of 20° C. to 170° C.

In some embodiments, the glass roll 1 may be installed on an unwinder 110 and may be configured such that a glass stack GS is unwound from the unwinder 110 in a roll-to-roll method. The glass stack GS may be configured to sequentially pass through a first material layer forming unit 120, a second material layer forming unit 130, a third material layer forming unit 140, a fourth material layer forming unit 150, and a fifth material layer forming unit 160. The glass stack GS may be wound into the glass roll 1 again through a rewinder 170 after sequentially passing through the first to fifth material layer forming units 120 to 160.

In some embodiments, any one of the first to fifth material layer forming units 120 to 160 may be configured to form, on the glass stack GS, a metal layer, a semiconductor layer, a transparent electrode layer, an inorganic material layer, an organic material layer, or the like, by a printing method, any one of a plurality of the first to fifth material layer forming units 120 to 160 may be configured to form, on the glass stack GS, a metal layer, a semiconductor layer, a transparent electrode layer, an inorganic material layer, an organic material layer, or the like, by a dry deposition method, and any one of the first to fifth material layer forming units 120 to 160 may be configured to form, on the glass stack GS, a metal layer, a semiconductor layer, a transparent electrode layer, an inorganic material layer, an organic material layer, or the like, by a coating method.

In some embodiments, the glass stack GS has a structure in which the glass ribbon 30 (see FIG. 2) is attached on the carrier film 20 (see FIG. 2), and may have an appropriate degree of flexibility to sequentially pass through the first to fifth material layer forming units 120 to 160 by the roll-to-roll process. Furthermore, the carrier film 20 may have sufficient mechanical stiffness to prevent damage to the glass ribbon 30 when sequentially passing through the first to fifth material layer forming units 120 to 160 by the roll-to-roll process.

In some embodiments, any one of the first to fifth material layer forming units 120 to 160 may be a vacuum-based manufacturing apparatus and may have a relatively high temperature. When passing through the vacuum-based and/or relatively high temperature material layer forming unit, in the glass stack GS, an organic material may not be evaporated or separated from the carrier film 20, and may have about a peel adhesion of less than or equal to 2.9 gf/in². After exposed to a high temperature, the carrier film 20 having a peel adhesion of less than or equal to 2.9 gf/in² may be easily separated or removed from the glass ribbon 30 after a device manufacturing process, such as a vacuum-based deposition or coating process or a cleaning process, is applied to the glass ribbon 30.

### EXPERIMENTAL EXAMPLE

Table 1 below shows an accelerated test method using a glass roll according to some embodiments.

TABLE 1

| Test Item | Test Condition | Target | Result |
|---|---|---|---|
| Accelerated | Stage 1: 170° C., 30 sec | No Cracks, | Pass |
| Environment | Stage 2: 100° C., 3 min | Bubbles, and | |
| Test 1 | Stage 3: 170° C., 40 sec | Visual Changes | |
| | Stage 4: 100° C., 3 min | | |
| | Stage 5: 170° C., 30 sec | | |
| Accelerated | 85° C., 85% RH, 7 days | No Cracks, | Pass |
| Environment | | Bubbles, and | |
| Test 2 | | Visual Changes | |
| Shock Absorption | ASTM D4169 | No Damage | Pass |
| Test | | | |
| Peel Adhesion | | Less than | Pass |
| | | or equal to | |
| | | 1.1 gf/in² | |
| Edge Strength | | 150 MPa | Pass |
| Surface Strength | | 500 MPa | Pass |

Referring to Table 1, Accelerated Environment Test 1 is to test compatibility with a high temperature condition of a device manufacturing process, in which a glass stack in which a glass ribbon is attached on a carrier film sequentially passed through Stage 1 to Stage 5, each having a different temperature condition. The glass stack having passed through Accelerated Environment Test 1 has no cracks, bubbles, or visual changes observed. Accelerated Environment Test 2 is a high temperature storage test, in which no cracks, bubbles, or visual changes are observed after the glass stack has been stored under conditions of 85° C. and 85% RH for 7 days.

The shock absorption test has been performed according to the ASTM D4169 standard, and no damage to the glass roll is observed after the shock absorption test has been performed. Furthermore, a peel adhesion of the carrier film to the glass ribbon is measured to be less than or equal to 1.1 gf/in². Furthermore, the edge strength and surface strength of glass ribbon is 150 MPa and 500 Mpa, respectively, and it is confirmed that the glass ribbon has sufficient strength.

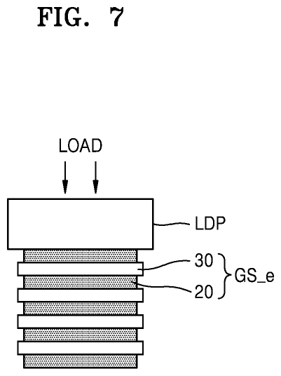

FIG. 7 is a schematic view of an aging test method by using the glass roll according to some embodiments.

Referring to FIG. 7, a glass sheet stack body GS_e includes a plurality of carrier films 20 and a plurality of glass ribbon 30, which are sequentially stacked on each other. For example, the carrier film 20 was prepared in a size of 100 mm*100 mm, and the glass ribbon 30 was prepared in a size of 150 mm*150 mm. The glass sheet stack body GS_e was disposed in a clean room, and a load of 19.7 kg or 1.97 gf/mm² was applied to the glass sheet stack body GS_e through a load plate LDP. After the glass sheet stack body GS_e with the load applied thereto has been stored in the clean room for 5 days, the glass sheet stack body GS_e was disassembled and whether an organic material remains on the surface of the glass ribbon 30 was measured with the naked eye, and by a pyrolysis-gas chromatograph/mass chromatograph (pyrolysis GC/MS) analysis method. As a result of aging test, it is confirmed that no residue of the organic material remains on the glass ribbon 30.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

1. A glass roll comprising:
a winding core having a central axis;
a carrier film wound on the winding core about the central axis; and
a glass ribbon wound on the carrier film about the central axis and attached onto the carrier film,
wherein the carrier film includes an adhesive face in contact with the glass ribbon and a non-adhesive face opposite the adhesive face, and
wherein the carrier film includes a peel adhesion of less than or equal to 2.9 gf/in².

2. The glass roll of claim 1, wherein the carrier film has a modulus of 250 MPa to 15 GPa.

3. The glass roll of claim 1, wherein the glass ribbon has a thickness of 10 micrometers to 100 micrometers, and
the carrier film has a thickness of 10 micrometers to 200 micrometers.

4. The glass roll of claim 1, wherein the carrier film has a roughness of less than or equal to about 30 nm.

5. The glass roll of claim 1, wherein the carrier film has a peel adhesion of less than or equal to 1.1 gf/in².

6. The glass roll of claim 1, wherein the carrier film comprises:
a base film including a first surface and a second surface; and
an adhesive layer attached onto the first surface of the base film, and
wherein a face of the adhesive layer defines the adhesive face of the carrier film.

7. The glass roll of claim 6, wherein the carrier film further includes a non-adhesive layer attached on the second surface of the base film, and
the surface of the non-adhesive layer defines the non-adhesive face of the carrier film.

8. The glass roll of claim 6, wherein the second surface of the base film defines the non-adhesive face of the carrier film.

9. The glass roll of claim 6, wherein the base film includes at least one of polypropylene and polyethylene, and
the adhesive layer includes at least one of polyolefin plastomers, alpha olefin copolymers, silicone resins, and photoreactive adhesive materials.

10. The glass roll of claim 1, wherein the non-adhesive face of the carrier film has no adhesion to a portion of the glass ribbon that is arranged adjacent to the non-adhesive face to be in contact with the non-adhesive face, and
when stored for more than 5 days at a temperature of 20° C. under a load of 1.97 gf/mm² in a state of the non-adhesive face of the carrier film contacting the portion of the glass ribbon, any component of the carrier film is not transferred onto a surface of the glass ribbon.

11. The glass roll of claim 1, wherein the adhesive face of the carrier film has a peel adhesion of less than or equal to 2.9 gf/in² at a temperature of 20° C. to 170° C.

12. A glass roll comprising:
a winding core having a central axis;
a carrier film wound on the winding core about the central axis; and
a glass ribbon wound on the carrier film about the central axis and attached onto the carrier film,
wherein the carrier film includes:
a base film including a first surface and a second surface opposite the first surface;
an adhesive layer attached on the first surface of the base film;
wherein the carrier film includes an adhesive face and a non-adhesive face opposite the adhesive face, the second surface of the base film defines the non-adhesive face, and the carrier film is attached to the glass ribbon such that the adhesive layer is in contact with the glass ribbon, and
wherein the carrier film includes a peel adhesion of less than or equal to 2.9 gf/in².

13. The glass roll of claim 12, wherein the carrier film has a modulus of 250 MPa to 15 GPa, and
the glass ribbon has a thickness of 10 micrometers to 100 micrometers.

14. The glass roll of claim 12, wherein the carrier film has a roughness of less than or equal to 30 nm.

15. The glass roll of claim 12, wherein the carrier film has a peel adhesion of less than or equal to 1.1 gf/in².

16. A glass roll comprising:
a winding core having a central axis;
a carrier film wound on the winding core about the central axis; and
a glass ribbon wound on the carrier film about the central axis and attached onto the carrier film,
wherein the carrier film includes an adhesive face and a non-adhesive face opposite the adhesive face, and
wherein the carrier film includes a peel adhesion of less than or equal to 2.9 gf/in² and a modulus ranging from 250 MPa to 15 GPa.

17. The glass roll of claim 16, wherein the base film includes at least one of polypropylene and polyethylene, and
the adhesive layer includes at least one of polyolefin plastomers, alpha olefin copolymers, silicone resins, and photoreactive adhesive materials.

18. The glass roll of claim 16, wherein the non-adhesive face of the carrier film has no adhesion to a portion of the glass ribbon that is arranged adjacent to the non-adhesive face to be in contact with the non-adhesive face, and
when stored for more than 5 days at a temperature of 20° C. under a load of 1.97 gf/mm² in a state of the non-adhesive face of the carrier film contacting the portion of the glass ribbon, any component of the carrier film is not transferred onto a surface of the glass ribbon.

19. The glass roll of claim 16, wherein the adhesive face of the carrier film has a peel adhesion of less than or equal to 2.9 gf/in² at a temperature of 20° C. to 170° C.

20. The glass roll of claim 16, further comprising:
a leader film arranged at a front side of the glass ribbon and attached on the adhesive face of the carrier film, one end of the leader film being attached on the winding core and overlapping a portion of the carrier film in a state to be unwound in a planar shape; and
a trailer film arranged at a rear side of the glass ribbon, and attached on the adhesive face of the carrier film.
